(19) United States
(12) Patent Application Publication
(10) Pub. No.: US 2012/0312660 A1
(43) Pub. Date: Dec. 13, 2012

(54) PRODUCTION SYSTEM WITH FEEDING CONVEYOR FOR SHEET-LIKE INTERMEDIATE LAYERS FOR FOOD PRODUCTS

(76) Inventors: Andreas Harder, Marburg (DE); Markus Gerhardt, Biedenkopf (DE)

(21) Appl. No.: 13/490,854

(22) Filed: Jun. 7, 2012

(30) Foreign Application Priority Data
Jun. 7, 2011 (DE) 10 2011 103 447.5

(51) Int. Cl. B65G 17/46; B65G 15/14

(52) U.S. Cl. 198/604; 198/690.1

(57) ABSTRACT

A production system with an apparatus serving as feeding conveyor is disclosed. The apparatus is designed to convey sheet-like goods, i.e. sheet-like intermediate layers, to be positioned underneath or between primarily flat food products, the apparatus comprising a counter-bearing arranged to directionally guide the goods to be conveyed. Moreover, at least one movable driving belt is arranged in the direction of transportation (T) parallel to the counter-bearing to carry on the goods to be conveyed. The driving belt presses the goods placed therebetween against the counter-bearing so that the conveyed goods are chucked between the counter-bearing and the driving belt. The counter-bearing is either magnetic or magnetizable, and the movable driving belt includes magnetizable elements so as to increase the frictional engagement between the driving belt and the goods to be conveyed.

### CROSS-REFERENCE TO RELATED APPLICATIONS

This application claims priority to German Patent Application 10 2011 103 447.5 filed on Jun. 7, 2011, which is hereby incorporated by reference in its entirety.

### TECHNICAL FIELD

The present disclosure relates to a production system with an apparatus serving as feeding conveyor, the apparatus being designed to convey sheet-like goods, i.e. sheet-like intermediate layers, especially paper or foil, to be positioned underneath or between primarily flat food products, the apparatus comprising a counter-bearing arranged to directionally guide the goods to be conveyed, and at least one movable driving belt designed to carry on the goods to be conveyed and being arranged in the direction of transportation parallel to the counter-bearing and urging the goods arranged therebetween against the counter-bearing so that the conveyed goods are chucked between the counter-bearing and the driving belt.

### BACKGROUND

Such apparatuses are known from the packaging industry and from the food processing industry as it is common use to transport or convey paper or plastic webs between driving belt and rollers or further driving belts serving as counter-bearing.

According to the WO 03/037 578 A1, an apparatus for slicing food products is known wherein a paper web is transported or conveyed in the direction of a cutting plane by means of a transportation system consisting of a driving belt and another driving belt serving as counter-bearing. A food product slice and a paper web portion are cut off simultaneously by means of a cutting blade. Then, the paper web portion drops down as an intermediate layer, together with the food product slice, to a collecting area for sliced products.

From DE 41 25 539 A1, a method for positioning separating foils between food product slices is known. The apparatus used comprises an acceleration device for the separating foils cut off from a continuous web and guided between belts in sliding engagement. The guiding rollers of the belts are arranged alongside the conveying apparatus and on both sides of the cut-off separating foil.

### SUMMARY

Based on such prior art, it is the object of the disclosure to provide a production system with an apparatus for conveying sheet-like intermediate layers to be positioned underneath or between primarily flat food products, such apparatus enabling to still further improve the frictional engagement between the driving belt and the goods to be conveyed so as to enable the apparatus to convey and make available sheet-like goods even at still higher transportation speeds with high accuracy.

This is especially important for methods where slices of a food product such as cheese, ham or cold meat are cut off at a high speed and the sheet-like goods to be conveyed serve as basis or intermediate layer and have, therefore, to be positioned exactly underneath or between such slices in order to prevent the slices sticking together.

Prior art conveyor belts are already known which are provided with permanent magnets, thus allowing magnetizable goods to be conveyed without slipping out of position on the conveyor belt.

The disclosure in one embodiment relates to a production system comprising a conveying apparatus, wherein the goods to be conveyed are sheet-like intermediate layers, especially foil or paper, to be positioned underneath or between primarily flat food products.

Positioning sheet-like bottom layers underneath food products may especially be done as follows: The conveying apparatus is arranged such that it provides a food slice from below with a sheet-like bottom layer running across a space between two conveyor belts used to convey or transport food product slices.

Providing intermediate layers between primarily flat food products may especially be done concurrently or immediately after a cutting process during which slices of a food product are being cut off.

An object of the disclosure is solved in that the counter-bearing is either magnetic or magnetizable, and the movable driving belt comprises magnetizable elements in order to increase the frictional engagement between the driving belt and the goods to be conveyed.

Accordingly, the counter-bearing can provide either in regions or over its entire length a permanent magnet or a passive magnet that can be magnetized by means of an electromagnet of the driving belt. Instead of permanent magnets, electromagnets may also be used in said counter-bearing.

The movable driving belt may comprise actively magnetizable elements in the form of electromagnets, or passively magnetizable elements such as e.g. magnetizable metal elements that can be magnetized by means of permanent magnets in the counter-bearing. Magnetizable elements are elements magnetizing in an external magnetic field so that they are attracted by a magnet but do not generate their own longer-lasting magnetic field. Primarily, the magnetizable elements are of a magnetically soft material and can, thus, be processed easily and favorably priced. It is further advantageous to use magentizable elements instead of magnetic elements in driving belts, as same can be designed in a more compact form and can be integrated into the driving belt more easily and more favorably than magnetic elements. In particular, thin metal sheets, wires, metal swarf and/or metal particles can be used as magnetizable elements.

Accordingly, magnetic forces can be generated between the driving belt and the counter-bearing urging the driving belt, especially in its region where it is not supported by rollers, towards the counter-bearing so that there is an increased normal force between driving belt and the sheet-like goods to be conveyed, thus immediately increasing the maximal static friction force of the frictional engagement in the direction of transportation.

In one embodiment, the counter-bearing is a stationary guide plate, with the goods to be conveyed lying flat against at the driving belt movably with regard to the plate. Thus, the sheet-like goods can be conveyed by means of just one driven element, viz. the driving belt, while being in tight engagement with the driving belt and sliding over the stationary guide plate.

In particular, the guide plate can be provided with guide elements such as, for instance, lateral projections or walls inducing the guidance of the sheet-like goods to be conveyed while the driving belt applies the advancing power onto the goods.

Advantageously, the frictional engagement between the goods to be conveyed and the movable driving belt is larger than between the goods to be conveyed and the guide plate, so that the goods to be conveyed can be moved in the direction of transportation along said guide plate by means of the driving belt. In particular, it will suffice when the maximal static friction force between the driving belt and the goods to be conveyed is larger than the sliding friction under operating conditions between guide plate and the goods to be conveyed. However, it is advantageous when the sliding friction between the goods to be conveyed and the guide plate is as low as possible, as otherwise this will just bring about heat and unnecessary power consumption.

According to one embodiment, the plate is arranged underneath the goods to be conveyed and the movable driving belt which presses the goods against the plate from above. Hence follows that both the gravitational force of the driving belt and the magnetic force of the magnetizable elements of the driving belt act towards the plate so that the driving belt can apply a high normal force to the sheet-like goods to be conveyed.

According to another embodiment, the plate is arranged above the goods to be conveyed and the movable driving belt which presses the goods to be conveyed against the plate from below. Such an arrangement is rendered possible precisely by the magnetizable elements of the driving belt according to the disclosure and by the magnetic or magnetizable counter-bearing, as even in this position a normal force presses, against the gravitational force, the driving belt against the plate from below.

Advantageously, the plate is made of metal. To this end, the plate includes metal insertions, or the plate is made of metal as a whole, especially in the form of sheet metal. The plate or the metal elements inside said plate can be made of a ferromagnetic material which interacts with an electromagnet in said movable driving belt but which in particular itself needs not or just slightly to be magnetic so that a passive or magnetically soft element suffices. In particular, the plate consists of a ferromagnetic material or a ferromagnetic alloy as already known from the prior art. Advantageously, the plate is magnetic, especially by making use of a permanently magnetic material.

In particular, the plate is electrically conductive.

According to another embodiment, the plate is connected to at least one electromagnet for magnetizing the plate. In preferred embodiments, a variety of electromagnets may especially be provided along the extension of the driving belt in said plate so that a continuous, almost constant magnetic field can be formed with regard to said driving belt.

Alternatively, permanent-magnetic elements may also be used instead of said electromagnet.

Advantageously, the magnetic attractive force of the plate can be changed by means of the electromagnet in order to variably set the frictional engagement between the driving belt and the goods to be conveyed. Thus, depending on the frictional force required between the driving belt and the goods to be conveyed, the normal force between driving belt, goods to be conveyed and plate can be adjusted. Hence follows that the ideal attractive force between plate and electromagnet can be adjusted for various kinds of sheet-like goods to be conveyed and for various speeds of transportation, respectively.

Making use of electromagnets has the further advantage that, in case the apparatus has to undergo some maintenance work, said electromagnets can be switched off so that the driving belt can simply be removed from the plate without being required to overcome the magnetic force, as it would be for permanent magnets.

Advantageously, the driving belt is a continuous toothed belt which is tensioned via at least two spaced-apart guiding gear wheels. Owing to the tension of the driving belt, the magnetizable elements are constantly provided at the plate so that they can be optimally pressed towards the plate by means of the magnetic force. However, according to the disclosure, minor pre-tensioning of the driving belt is required, as the magnetizable elements of the driving belt and the magnetic or magnetizable guide plate allows to apply a normal force between said driving belt and said plate which, according to the prior art applications, has to be enabled just by means of pre-tensioning or by intermediate rollers. Owing to the toothed belt design, no slip can occur between the driving belt and the guiding gear wheels and, thus, the driving belt can be controlled with high accuracy.

According to one embodiment, the plate and the driving belt are arranged horizontally. Thus, the goods can be conveyed horizontally.

Advantageously, the plate and the driving belt can be tilted about an angle in order to allow that the goods can be conveyed in either ascending or descending manner. Accordingly, owing to the magnetizability of the guide plate and the magnetizable elements of the movable driving belt according to the disclosure, goods can also be conveyed obliquely in a reliable manner.

In one embodiment, the driving belt includes plastic material. Plastic material is flexible enough for manufacturing a driving belt which can pass around the deflection rollers provided at both ends of the driving belt without making use of joints or links. For instance, rubber materials are conceivable for such driving belt which are of high resistivity against abrasion and fatigue and further include a high friction coefficient with regard to the goods to be conveyed. On the other hand, driving belts made of a rigid plastic material are also conceivable which are composed of individual members combined by joints. Beyond that, plastic material enables that the magnetizable elements which predominantly are made of metal can be fastened easily to the driving belt, can particularly be inserted therein. This can be done, for instance, by providing magnetizable elements while the driving belt is being cast. However, in other embodiments, said magnetizable elements may also be fastened at the inner side of the driving belt after being manufactured, especially by bonding, but also by screw-fitting or by inserting same into pre-cast clip connections.

Further, it may also be possible that the magnetizable elements of the driving belt are metal elements forming chain members of said driving belt. Add-on attachments made of plastic material or rubber may then be attached to such metal chain members, thus forming a contact area for the goods to be conveyed.

According to another embodiment, the magnetizable elements are steel cords embedded into the driving belt. Such steel cords are predominantly passively magnetizable ferromagnetic elements interacting with permanent magnets or electromagnets of the guide plate. To this end, steel cords advantageously improve the driving belt strength and allow for the magnetizability, but do not substantially diminish the flexibility of the driving belt with regard to the bending around the deflection points of the driving belt.

Advantageously, the plate includes a surface of minor friction. Said minor friction surface can be obtained by either surface coating the plate, for instance by polymer-coating a metal surface, or by polymer-coating a plate of plastic material. On the other hand, a plate of minor surface friction can also be obtained by providing the surface with smallest possible roughness and high hardness. To this end, e.g. thermosetting surfaces or ground metal surfaces can be used.

In yet another embodiment, the counter-bearing is a conveyor belt. Said conveyor belt can, on the one hand, be driven passively by frictional contact with the driving belt and/or by frictional contact with the goods to be conveyed in such a manner that it moves along with the driving belt either subject to slip or slip-free. However, on the other hand, there might also be a mechanical connection via belts or gear wheels for synchronizing the conveyor belt with the driving belt. Finally, it may also be possible to provide the conveyor belt with an own correspondingly controlled driving mechanism so that it can be driven synchronously with said driving belt. In particular, the conveyor belt can have the same length as the driving belt and/or can extend in the same direction as the driving belt. Important is that a contact area of the conveyor belt lies close against, at least partially, to a contact area of the driving belt so that sheet-like goods to be conveyed can be transported or conveyed between the conveyor belt and the driving belt. Synchronous conveyor belt running with regard to the driving belt is an advantageous property but is not compulsory necessary for all embodiments, as a certain slip between the sheet-like goods to be conveyed and the conveyor belt is harmless for the most embodiments. The conveyor belt may have the same width as the driving belt. However, in other embodiments, the conveyor belt may be substantially broader than the driving belt. Forming the counter-bearing as a conveyor belt has the advantage that there is no or minor relative movement between the sheet-like goods to be conveyed and the counter-bearing, which is in contrast to the embodiments where the counter-bearing is in the form of a stationary guide plate. On the other hand, forming the counter-bearing as a conveyor belt involves more efforts.

Similar to the guide plate, the conveyor belt can be provided with guide elements forming a lateral boundary which extends in the direction of transportation thus guiding the sheet-like goods while being conveyed in the direction of transportation.

Advantageously, the conveyor belt includes magnetic elements which interact with the magnetizable driving belt elements. To have the counter-bearing in the form of a conveyor belt with magnetic elements causes that the magnetizable driving belt elements can be made as passive magnetic elements. The magnetic conveyor belt elements are, above all, permanent magnets. Alternatively, magnetizable elements in the form of electromagnets can also be provided in the conveyor belt. Such electromagnets can also be provided stationary below the conveyor belt.

The conveyor belt and the driving belt are attracted towards each other by means of the magnetic forces and, accordingly, a high normal force is applied between conveyor belt and driving belt which allows for a safe frictional engagement between the driving belt and the goods to be conveyed and, in addition, predominantly also between the driving belt and the conveyor belt.

Preferentially, the conveyor belt is designed to be driven at the same speed as the driving belt. This can be done either by coupling elements such as gear wheels or belts or by an own controlled control of the conveyor belt by means of a driving motor.

The disclosure further relates to a cutting device, comprising an apparatus for conveying sheet-like goods as described above in order to supply the goods to a cutting element. These kinds of cutting devices may especially advantageously be used in food processing systems. Separating foils or sheets which are placed between two individual slices of a food product are wound off a continuous web and transported, by means of the conveying apparatus according to the disclosure, to a cutting element. The cutting element cuts out individual separating sheets from the sheet-like goods to be conveyed, which are placed between slices of a food product.

A conveying apparatus according to the disclosure can be used to transport a continuous web of sheet-like goods to a cutting element for food products, thus enabling the food product cutting device to simultaneously cut a food product slice and a portion of the sheet-like material which are together placed on another transportation device or on a tray. Hence follows that one food product slice and one separation foil are alternately arranged on a stack.

Alternatively, the cutting device can also be arranged prior to the conveying apparatus according to the disclosure so that the detached separation sheets or foils already cut off by said cutting device can be further conveyed as the sheet-like goods to be conveyed by means of said conveying apparatus. In particular, the conveying apparatus can be used for the transportation of the detached goods to a cutting element used to cut slices from a food product so that the separation sheets or foils of the goods to be conveyed and the food product slices may alternately be arranged one onto the other.

In the following, the disclosure will be described with reference to some alternative embodiments.

### BRIEF DESCRIPTION OF THE DRAWINGS

FIG. 1 is a schematic side view of a first embodiment of an apparatus for conveying sheet-like goods for a production system.

FIG. 2 is a schematic side view of another embodiment of an apparatus for conveying sheet-like goods for a production system.

FIG. 3 is a schematic side view of a third embodiment of an apparatus for conveying sheet-like goods for a production system.

FIG. 4 is a detailed plan view of a configuration of the first or second embodiment of the apparatus for conveying sheet-like goods.

FIG. 5 is a sectional view A-A of the embodiment of FIG. 4.

FIG. 6 is a perspective view of the embodiment of FIGS. 4 and 5.

FIG. 7 is a schematic view of a production system with an embodiment of the apparatus for conveying sheet-like goods.

FIG. 8 is a schematic view of another production system with an embodiment of the apparatus for conveying sheet-like goods.

### DETAILED DESCRIPTION

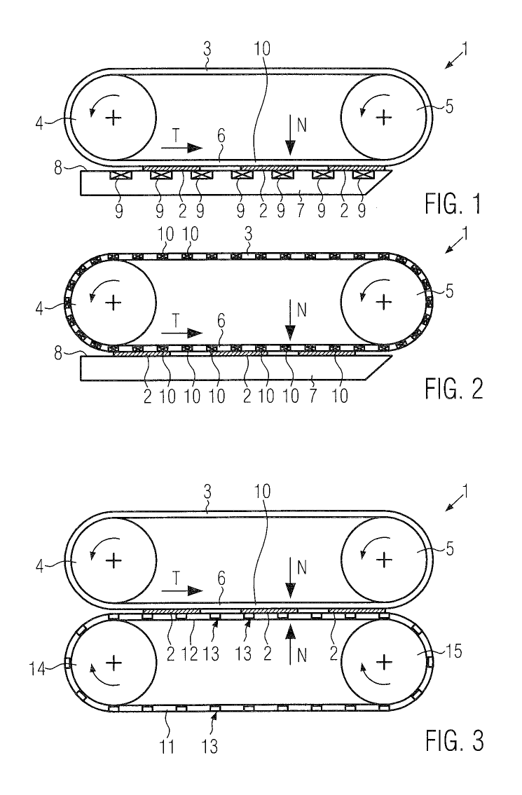

FIG. 1 shows an apparatus 1 for conveying sheet-like goods 2. The conveying apparatus comprises a driving belt 3 horizontally extending between two pulleys 4 and 5 of substantially the same size.

The horizontally extending lower portion of driving belt 3 forms a contact area 6. A counter-bearing in the form of a stationary guide plate 7, the upper side thereof forming a contact area 8, extends parallel thereto. The sheet-like goods to be conveyed 2 are arranged between contact area 6 of driving belt 3 and guide plate 7, said goods substantially extending also parallel to contact area 6 of driving belt 3 and to contact area 8 of guide plate 7.

According to FIG. 1, driving belt 3 is slightly spaced apart from guide plate 7. This primarily serves to obtain a more distinct representation, as in case of the most embodiments the sheet-like goods to be conveyed 2 are so thin that contact area 6 of driving belt 3 is in contact with guide plate 7 in the regions between, before and behind said sheet-like goods 2.

A plurality of magnetizable or magnetic elements 9 are arranged in guide plate 7, primarily in the region of contact area 6 of driving belt 3. The magnetizable or magnetic elements 9 are designed to generate a magnetic force interacting with magnetizable elements 10 of driving belt 3.

In FIG. 1, the magnetizable elements 10 of driving belt 3 are not separately shown, as they are steel cords embedded in driving belt 3 and extending along the entire length thereof. Magnetizable elements 10 are magnetically soft, magnetizable elements without own substantial magnetic field which are attracted by the magnetic field of said magnetizable or magnetic elements 9. The magnetizable or magnetic elements 9 are, for instance, permanent magnets. Alternatively, electromagnets are used whose magnetic force can be set such that it is adapted to the goods to be conveyed and to each conveying application.

Due to the magnetic force exerted by magnetizable or magnetic elements 9, magentizable elements 10 in the form of steel cords are attracted towards guide plate 7 in contact area 6 of driving belt 3 so that an increased normal force N is generated orthogonally to the surface of guide plate 7 and orthogonally to the direction of transportation T.

The increased normal force N between contact area 6 and guide plate 7 is the normal force in sliding contact between the sheet-like goods 2 and driving belt 3 so that the frictional engagement between driving belt 3 and goods 2 can be improved. Concurrently is contact area 8 at the upper side of guide plate 7 designed such that the sheet-like goods can glide over it easily so that no slip occurs between the sheet-like goods to be conveyed 2 and driving belt 3. The sheet-like goods 2 are held at a defined position with regard to driving belt 3 and can, thus, be made available in subsequently following processing or conveying stations at a precisely defined point in time.

FIG. 2 shows another embodiment of the conveying apparatus, wherein, in contrast to the first embodiment, a plurality of magnetizable elements 10 in the form of electromagnets is arranged in driving belt 3. On the other hand, guide plate 7 does not include any separate magnetic elements but is made of a magnetizable ferromagnetic material interacting with the electromagnets in said driving belt. In particular, stationary guide plate 7 is made in the form of a high-grade steel plate.

Owing to electromagnets 10 in driving belt 3, a normal force N is applied orthogonally to the direction of transportation T in contact area 6 of driving belt 3 onto guide plate 7 via driving belt 3, thus improving the frictional engagement between the sheet-like goods to be conveyed and driving belt 3. Preferably, magnetizable elements 10 are arranged in driving belt 3 along the entire driving belt 3 in a spaced-apart manner. The distance between electromagnets 10 is selected such that, on the one hand, a continuous magnetic field can be generated along driving belt 3 and, on the other hand, there is still sufficiently high flexibility of driving belt 3 for being deflected around pulleys 4, 5. Advantageously, electromagnets 10 are coils which are flat in normal direction N so that driving belt 3 can be of a relatively thin design. In one embodiment, said coils are directly cast into driving belt 3. Lines are provided for said electromagnets 10 along driving belt 3, as well as the feeding of electricity into driving belt 3 via pulleys 4, 5. Such feeding can also be done by induction.

FIG. 3 shows a third embodiment of the conveying apparatus, wherein here a conveyor belt 11 has been provided as counter-bearing extending parallel in its contact area 12 formed by the upper portion and preferably at least partially in contact with contact area 6 of driving belt 3. Sheet-like goods to be conveyed 2 are provided between contact area 12 of conveyor belt 11 and contact area 6 of driving belt 3, which are in frictional engagement with at least driving belt 3 so that no slip will occur between driving belt 3 and sheet-like goods 2.

The design of driving belt 3 may be selected either as described for the first embodiment or as described for the second embodiment, driving belt 3 again including a plurality of magnetizable elements 10 in order to increase the frictional engagement between driving belt 3 and goods 2. Conveyor belt 11 is either magnetic or magnetizable, namely either by the provision of magnetizable elements 13 or by the fact that conveyor belt 11 is magnetic as such, e.g. by embedding permanent magnets.

In one embodiment, conveyor belt 11 is broader than driving belt 3, thus enabling to provide magnetic elements 13 in conveyor belt 11 easier.

Owing to the interaction of the magnetizable or magnetic conveyor belt with the magnetizable elements 10 of driving belt 3, a normal force N is generated which acts orthogonally on both sides in the direction of transportation T onto sheet-like goods to be conveyed 2.

Conveyor belt 11 includes pulleys 14, 15 substantially arranged with regard to the direction of transportation in the same section as pulleys 4, 5 of driving belt 3 corresponding thereto, respectively. Pulleys 14, 15 include a separate drive that can be synchronized to the drive of pulleys 4, 5. Alternatively, however, a mechanical synchronization via an additional belt between the pulleys of conveyor belt 11 and driving belt 3 is also possible. Finally, it is, however, also possible to have conveyor belt 11 being designed as a passive element which is driven just by means of the frictional contact between driving belt 3 and conveyor belt 11 as well as goods to be conveyed 2 and conveyor belt 11. According to FIG. 3, contact area 6 of driving belt 3 and contact area 12 of conveyor belt 11 are shown remote from each other for reasons of clarity. During normal operation, however, the sheet-like goods to be conveyed 2 are, in most embodiments, so thin that contact area 6 of driving belt 3 and contact area 12 of conveyor belt 11 are in contact with each other in those regions where there are no sheet-like goods 2 between contact areas 6, 12.

Due to magnetizable elements 10, 13, the normal force between contact area 6 of driving belt 3 and contact area 12 of conveyor belt 11 is increased so as to enable goods to be conveyed 2 to be seized and conveyed safely, without any slip between goods 2 and driving belt 3 occurring.

Advantageously, also no slip occurs between conveyor belt 11 and goods to be conveyed 2 which is not required for all embodiments. It rather suffices when there is no slip just between driving belt 3 and goods to be conveyed 2, as the position of the goods to be conveyed is, thus, clearly determined so as to make the goods available for another processing station or another conveying device at a desired, predetermined moment of time.

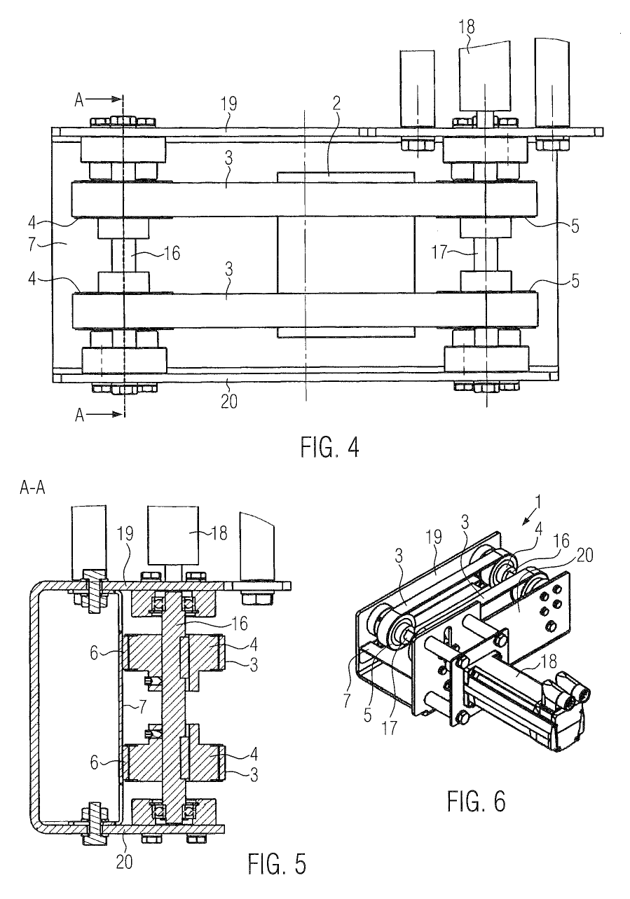

FIG. 4 shows a detailed configuration of the embodiment of conveying apparatus 1 shown in either of FIG. 1 or 2. Conveying apparatus 1, in turn, includes stationary guide plate 7 horizontally extending as counter-bearing. Above said plate, two driving belts 3 are positioned, contact areas 6 thereof being parallel to guide plate 7 and at least partially in contact therewith. Driving belts 3 are tensioned between front pulleys 5 and rear pulleys 4, the front pulleys 5 being arranged on a front shaft 17 and the rear pulleys 4 being arranged on a rear shaft 16. Pulleys 4, 5 are arranged on shafts 16, 17, respectively, by means of a torsion-proof feather-key connection.

A driving element 18, especially an electromotor, is flanged to front shaft 17 for synchronously driving the driving belt 3. This is possible due to the torsion-proof connection of pulleys 5 to front shaft 17.

Guide plate 7 is restricted at its sides by means of side walls 19, 20, which side walls 19, 20 being able to form, at least in some embodiments, guide elements for the sheet-like goods to be conveyed 2. Alternatively, extra guide elements may be provided on guide plate 7.

As was already the case in the previous embodiments, stationary guide plate 7 is designed as a magnetic or magnetizable counter-bearing and the movable driving belt comprises magnetizable elements so as to increase the frictional engagement between driving belt and the goods to be conveyed.

FIG. 5 shows a sectional view along section line A-A in FIG. 4, the torsion-proof arrangement of pulleys 4 on rear shaft 16 being shown by means of a feather key. Driving belts 3 are of a width extending merely over a partial region of the entire width of the goods to be conveyed 2. In particular, sheet-like goods to be conveyed 2 are driven by two driving belts 3 guided in parallel which are spaced apart from each other. In contrast thereto, guide plate 7 primarily extends at least in the width of the goods to be conveyed 2 so as to form a base or support for the entire goods to be conveyed 2.

The same primarily also applies to the other embodiments having a conveyor belt as counter-bearing. In this case, the conveyor belt especially also extends over a larger width than the driving belt/s assigned thereto. Furthermore, various driving belts arranged in parallel, especially two driving belts similar to those in the embodiment of FIGS. 4 to 6, may also be provided.

FIG. 6 is an isometric view of the embodiment according to FIGS. 4 and 5, the motor 18 being shown in an entirely flange-mounted manner.

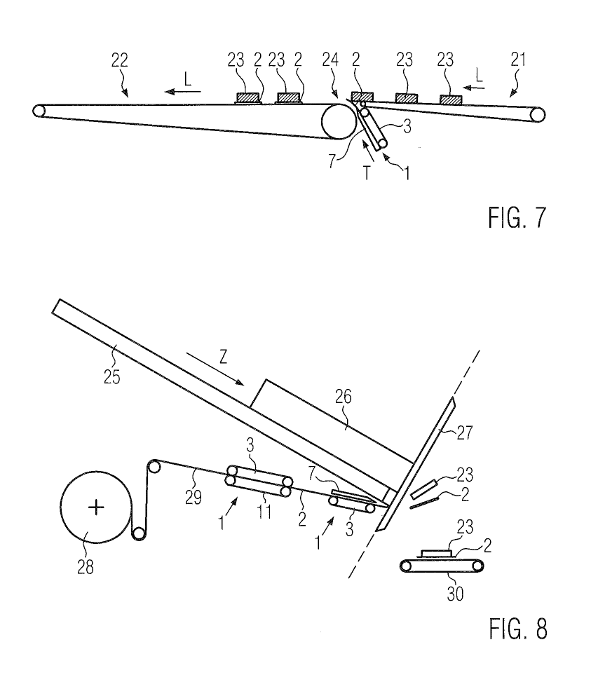

FIG. 7 shows a production system according to the disclosure with the apparatus for conveying sheet-like goods. A first conveyor belt 21 is used to transport sliced food products in the form of slices 23, for instance single slices of cold meat, ham or cheese etc., in the direction of transportation L to another conveyor belt 22. Food product slices 23 are schematically shown in a relatively thick manner; in concrete embodiments these are thin, single slices of such products of a common thickness.

A small gap 24 is provided between the first conveyor belt 21 and the second conveyor belt 22 to receive an embodiment of the conveying apparatus 1. In this embodiment, this particularly refers to the first or the second embodiment of conveying apparatus 1, however, the third embodiment of said conveying apparatus might be provided as well.

The direction of transportation T of the goods to be conveyed 2 extends obliquely upwards, with conveying apparatus 1 being controlled in such a manner that as soon as a slice 23 leaves the first conveyor belt 21 one of said sheet-like goods 2 is supplied to said slice 23 in form of a bottom layer. Thus, slice 23 is placed on bottom layer 2 before or while being positioned on second conveyor belt 22.

The single food product slices 23 are further conveyed together with bottom layers 2 on conveyor belt 22 in the direction of transportation 11 and can, after that, be stacked so as to have one of the sheet-like goods 2 lying between two single slices 23.

It is, thus, prevented that single slices 23 stick together. In FIG. 7, the sheet-like goods to be conveyed 2 in the form of bottom layers are supplied as separate or single goods.

Yet another production system according to the disclosure with conveying apparatuses is shown in FIG. 8. A food product block 26, for instance a cheese, cold meat or the like, is placed on a conveying web 25. Block 26 is transported to a rotating cutting blade 27 in the direction of transportation Z, so as to cut one food product slice 23 from block 26, respectively.

Moreover, a roller 28 is provided with a sheet-like good 2, especially a paper web 29, said roller first being conducted through a conveying apparatus 1 according to FIG. 3 and then through a conveying apparatus 1 according to FIG. 1 or 2. The sheet-like goods to be conveyed 2 also run through the cutting plane of cutting blade 27, the advance of said conveying apparatus being set in such a manner that food product slice 23 is concurrently cut by said cutting blade 27 together with one portion of the sheet-like good 2.

Accordingly, single food product slices 23 are separated by intermediate layers 2 when they are piled-up either on the conveyor belt 30 or at a later time. Instead of conveyor belt 30, a collecting area may also be provided from which food product slices 23 with intermediate layers 2 lying therebetween can then be taken away.

1. A production system, comprising an apparatus serving as feeding conveyor, wherein the apparatus is designed to convey sheet-like goods to be conveyed, viz. sheet-like intermediate layers to be positioned underneath or between primarily flat food products, the apparatus including a counter-bearing arranged to directionally guide the goods to be conveyed and at least one movable driving belt for carrying along the goods to be conveyed and arranged in the direction of transportation (T) parallel to the counter-bearing and pressing the goods to be conveyed arranged therebetween against the counter-bearing so that the conveyed goods are chucked between the counter-bearing and the driving belt,
characterized in that
the counter-bearing is either magnetic or magnetizable and the movable driving belt includes magnetizable elements in order to increase the frictional engagement between the driving belt and the goods to be conveyed.

2. The production system as set forth in claim 1, characterized in that the counter-bearing is a stationary guide plate, with the goods to be conveyed lying close against the driving belt in a movable manner with regard to the plate.

3. The production system as set forth in claim 2, characterized in that the frictional engagement between the goods to be conveyed and the movable driving belt is larger than between the goods to be conveyed and the guide plate, so that the goods to be conveyed can be moved along guide plate via the driving belt in the direction of transportation (T).

4. The production system as set forth in claim 2, characterized in that the plate is arranged below the goods to be conveyed and the movable driving belt which presses the goods to be conveyed against the plate from above.

5. The production system as set forth in claim 2, characterized in that the plate is arranged above the goods to be conveyed and the movable driving belt which presses the goods to be conveyed against the plate from below.

6. The production system as set forth in claim 2, characterized in that the plate is made of metal.

7. The production system as set forth in claim 2, characterized in that the plate is electrically conductive.

8. The production system as set forth in claim 2, characterized in that the plate is connected with at least one electromagnet for magnetizing the plate.

9. The production system as set forth in claim 2, characterized in that an attractive magnetic force of the plate can be changed by the electromagnet in order to variably set the frictional engagement between the driving belt and the goods to be conveyed.

10. The production system as set forth in claim 1, characterized in that the driving belt is a continuous toothed belt which is tensioned via at least two spaced-apart guiding gear wheels.

11. The production system as set forth in claim 2, characterized in that the plate and the driving belt are arranged horizontally.

12. The production system as set forth in claim 2, characterized in that the plate and the driving belt can be tilted around an angle for conveying the goods to be conveyed in either ascending or descending manner.

13. The production system as set forth in claim 1, characterized in that the driving belt includes a plastic material.

14. The production system as set forth in claim 1, characterized in that the magnetizable elements are steel cords which are embedded in the driving belt.

15. The production system as set forth in claim 2, characterized in that the plate includes a low-friction surface.

16. The production system as set forth in claim 1, characterized in that the counter-bearing is a conveyor belt.

17. The production system as set forth in claim 16, characterized in that the conveyor belt includes magnetic elements interacting with the magnetizable elements of the driving belt.

18. The production system as set forth in claim 16, characterized in that the conveyor belt is designed to be driven at the same speed as the driving belt.

19. The production system as set forth in claim 1, comprising a cutting device including the apparatus for conveying sheet-like goods in order to transport the goods to be conveyed either to a cutting element or away from a cutting element.
